(19) United States
(12) Patent Application Publication
(10) Pub. No.: US 2026/0318499 A1
(43) Pub. Date: Oct. 15, 2026

(54) RADIATION-RESISTANT LED LAMP MODULE

(71) Applicant: Paragon Semiconductor Lighting Technology Inc., Diamond Bar, CA (US)

(72) Inventor: CHIA-TIN CHUNG, Midland, MI (US)

(21) Appl. No.: 19/433,084

(22) Filed: Dec. 26, 2025

(30) Foreign Application Priority Data
Apr. 14, 2025 (TW) 114203641

(51) Int. Cl. F21V 3/06; F21Y 115/10

(52) U.S. Cl. CPC F21V 3/06; F21Y 2115/10

(57) ABSTRACT

A radiation-resistant LED lamp module includes an illumination light generating structure, a top anti-radiation structure, an anti-radiation light-transmitting structure, a bottom anti-radiation structure and a surrounding anti-radiation structure. The illumination light generating structure includes a plurality of LED elements. The top anti-radiation structure includes a top anti-radiation element disposed above the illumination light generating structure. The anti-radiation light-transmitting structure includes a first anti-radiation light-transmitting element disposed above the illumination light generating structure and a second anti-radiation light-transmitting element disposed above the first anti-radiation light-transmitting element. The bottom anti-radiation structure includes a bottom anti-radiation element disposed below the illumination light generating structure. The surrounding anti-radiation structure includes a surrounding anti-radiation element disposed around the illumination light generating structure. The illumination light generating structure can be completely enclosed by the top anti-radiation element, the first anti-radiation light-transmitting element, the bottom anti-radiation element and the surrounding anti-radiation element.

### CROSS-REFERENCE TO RELATED PATENT APPLICATION

This application claims the benefit of priority to Taiwan Patent Application No. 114203641, filed on Apr. 14, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a lamp module, and more particularly to a radiation-resistant LED lamp module.

### BACKGROUND OF THE DISCLOSURE

In the related art, LED lamps are susceptible to radiation damage in high radiation environments and there is room for improvement.

### SUMMARY OF THE DISCLOSURE

In response to the above-referenced technical inadequacy, the present disclosure provides a radiation-resistant LED lamp module.

In order to solve the above-mentioned problems, one of the technical aspects adopted by the present disclosure is to provide a radiation-resistant LED lamp module, which includes an illumination light generating structure, a top anti-radiation structure, an anti-radiation light-transmitting structure, a bottom anti-radiation structure and a surrounding anti-radiation structure. The illumination light generating structure includes a circuit substrate and a plurality of LED elements disposed on the circuit substrate. The top anti-radiation structure includes a top anti-radiation element disposed above the illumination light generating structure. The anti-radiation light-transmitting structure includes a first anti-radiation light-transmitting element disposed above the illumination light generating structure and a second anti-radiation light-transmitting element disposed above the first anti-radiation light-transmitting element. The bottom anti-radiation structure includes a bottom anti-radiation element disposed below the illumination light generating structure. The surrounding anti-radiation structure includes a surrounding anti-radiation element disposed around the illumination light generating structure. The anti-radiation light-transmitting structure is configured to be separated from the illumination light generating structure, and the bottom anti-radiation structure is configured to contact the circuit substrate of the illumination light generating structure. The first anti-radiation light-transmitting element is configured as a first lead-containing light-transmitting element or a first boron-containing light-transmitting element detachably disposed above the illumination light generating structure, and the second anti-radiation light-transmitting element is configured as a second lead-containing light-transmitting element or a second boron-containing light-transmitting element detachably disposed above the illumination light generating structure. The illumination light generating structure is completely enclosed by the top anti-radiation element, the first anti-radiation light-transmitting element, the bottom anti-radiation element and the surrounding anti-radiation element.

In order to solve the above-mentioned problems, another one of the technical aspects adopted by the present disclosure is to provide a radiation-resistant LED lamp module, which includes an illumination light generating structure, a top anti-radiation structure, an anti-radiation light-transmitting structure, a bottom anti-radiation structure and a surrounding anti-radiation structure. The illumination light generating structure includes a circuit substrate and a plurality of LED elements disposed on the circuit substrate. The top anti-radiation structure includes a top anti-radiation element disposed above the illumination light generating structure. The anti-radiation light-transmitting structure includes a first anti-radiation light-transmitting element disposed above the illumination light generating structure and a second anti-radiation light-transmitting element disposed above the first anti-radiation light-transmitting element. The bottom anti-radiation structure includes a bottom anti-radiation element disposed below the illumination light generating structure. The surrounding anti-radiation structure includes a surrounding anti-radiation element disposed around the illumination light generating structure. The first anti-radiation light-transmitting element is configured as a first lead-containing light-transmitting element or a first boron-containing light-transmitting element detachably disposed above the illumination light generating structure, and the second anti-radiation light-transmitting element is configured as a second lead-containing light-transmitting element or a second boron-containing light-transmitting element detachably disposed above the illumination light generating structure.

In order to solve the above-mentioned problems, yet another one of the technical aspects adopted by the present disclosure is to provide a radiation-resistant LED lamp module, which includes an illumination light generating structure, a top anti-radiation structure, an anti-radiation light-transmitting structure, a bottom anti-radiation structure and a surrounding anti-radiation structure. The illumination light generating structure includes a circuit substrate and a plurality of LED elements disposed on the circuit substrate. The top anti-radiation structure includes a top anti-radiation element disposed above the illumination light generating structure. The anti-radiation light-transmitting structure includes a first anti-radiation light-transmitting element disposed above the illumination light generating structure and a second anti-radiation light-transmitting element disposed above the first anti-radiation light-transmitting element. The bottom anti-radiation structure includes a bottom anti-radiation element disposed below the illumination light generating structure. The surrounding anti-radiation structure includes a surrounding anti-radiation element disposed around the illumination light generating structure. The illumination light generating structure is completely enclosed by the top anti-radiation element, the first anti-radiation light-transmitting element, the bottom anti-radiation element and the surrounding anti-radiation element.

Therefore, in the radiation-resistant LED lamp module provided by the present disclosure, by virtue of “the top anti-radiation structure including a top anti-radiation element disposed above the illumination light generating structure,” “the anti-radiation light-transmitting structure including a first anti-radiation light-transmitting element disposed above the illumination light generating structure and a second anti-radiation light-transmitting element disposed above the first anti-radiation light-transmitting element,” “the bottom anti-radiation structure including a bottom anti-radiation element disposed below the illumination light generating structure” and “the surrounding anti-radiation structure including a surrounding anti-radiation element disposed around the illumination light generating structure,” the radiation damage to the illumination light generating structure in high radiation environments can be reduced.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective exploded view of a radiation-resistant LED lamp module according to a first embodiment of the present disclosure;

FIG. 2 is a partial schematic perspective exploded view of the radiation-resistant LED lamp module according to the first embodiment of the present disclosure;

FIG. 3 is another partial schematic perspective exploded view of the radiation-resistant LED lamp module according to the first embodiment of the present disclosure;

FIG. 4 is a schematic perspective assembled view of the radiation-resistant LED lamp module according to the first embodiment of the present disclosure;

FIG. 5 is a schematic cross-sectional view taken along line V-V of FIG. 4;

FIG. 6 is a schematic enlarged view of part VI of FIG. 5;

FIG. 7 is a schematic view of the configuration relationship between the first anti-radiation light-transmitting element and the second anti-radiation light-transmitting element of the anti-radiation light-transmitting structure according to the first embodiment of the present disclosure;

FIG. 8 is a schematic view of the radiation-resistant LED lamp module being configured to be detachably and movably disposed on a ceiling bracket structure according to the first embodiment of the present disclosure;

FIG. 9 is a schematic view of the configuration relationship between the first anti-radiation light-transmitting element and the second anti-radiation light-transmitting element of the anti-radiation light-transmitting structure according to a second embodiment of the present disclosure; and

FIG. 10 is a schematic view of the configuration relationship between the first anti-radiation light-transmitting element and the second anti-radiation light-transmitting element of the anti-radiation light-transmitting structure according to a third embodiment of the present disclosure.

### DETAILED DESCRIPTION OF THE EXEMPLARY EMBODIMENTS

The present disclosure is more particularly described in the following embodiments and examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

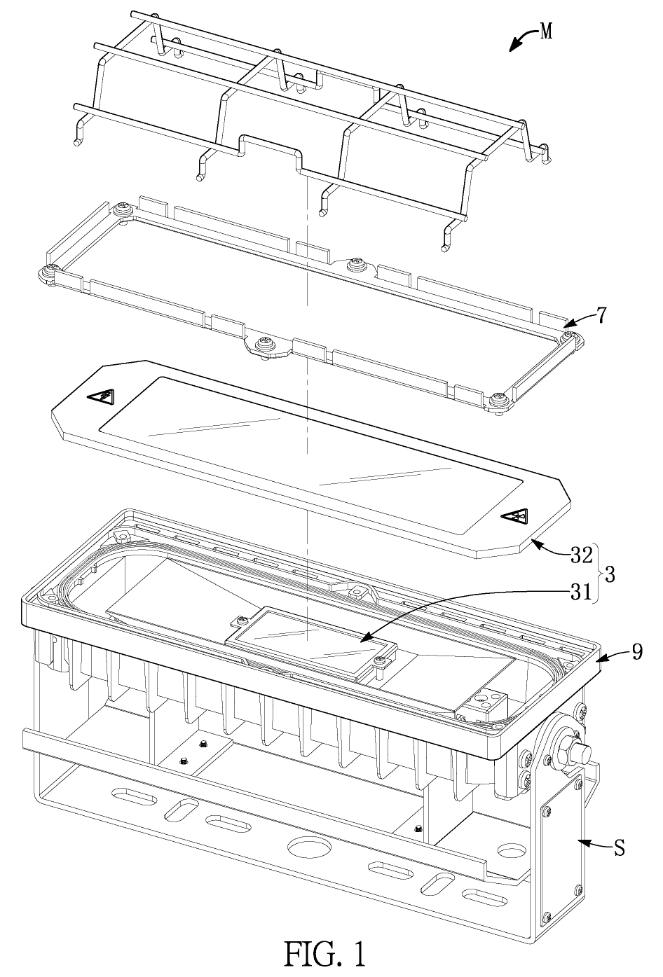

Referring to FIG. 1 to FIG. 10, the present disclosure provides a radiation-resistant LED lamp module M, which may at least include an illumination light generating structure 1, a top anti-radiation structure 2, an anti-radiation light-transmitting structure 3, a bottom anti-radiation structure 4 and a surrounding anti-radiation structure 5. More particularly, the illumination light generating structure 1 may at least include a circuit substrate 10 and a plurality of LED elements 11 that can be disposed on the circuit substrate 10, and the top anti-radiation structure 2 may at least include a top anti-radiation element 20 that can be disposed above the illumination light generating structure 1. Moreover, the anti-radiation light-transmitting structure 3 may at least include a first anti-radiation light-transmitting element 31 that can be disposed above the illumination light generating structure 1 and a second anti-radiation light-transmitting element 32 that can be disposed above the first anti-radiation light-transmitting element 31. In addition, the bottom anti-radiation structure 4 may at least include a bottom anti-radiation element 40 that can be disposed below the illumination light generating structure 1, and the surrounding anti-radiation structure 5 may at least include a surrounding anti-radiation element 50 that can be disposed around the illumination light generating structure 1. It should be noted that the illumination light generating structure 1 can be completely enclosed by the top anti-radiation element 20, the first anti-radiation light-transmitting element 31, the bottom anti-radiation element 40 and the surrounding anti-radiation element 50, thereby reducing the radiation damage that the illumination light generating structure 1 may suffer in a high radiation environment.

### First Embodiment

Referring to FIG. 1 to FIG. 8, a first embodiment of the present disclosure provides a radiation-resistant LED lamp module M (or an anti-radiation light-emitting diode lamp module M), which may at least include an illumination light generating structure 1 (a light source providing structure), a top anti-radiation structure 2, an anti-radiation light-transmitting structure 3, a bottom anti-radiation structure 4 and a surrounding anti-radiation structure 5.

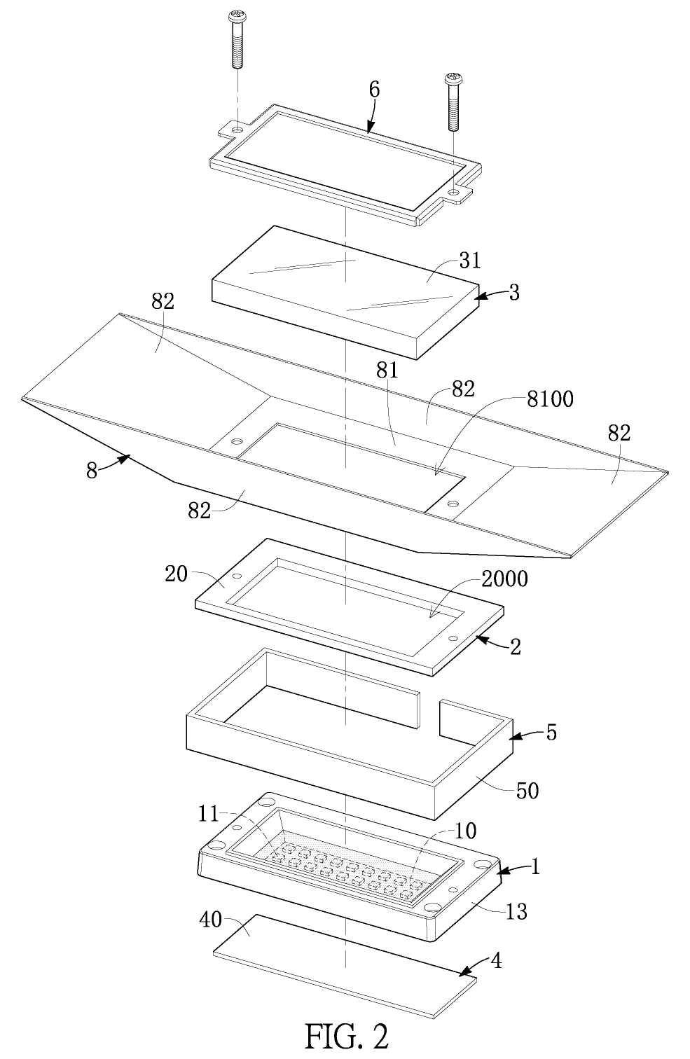

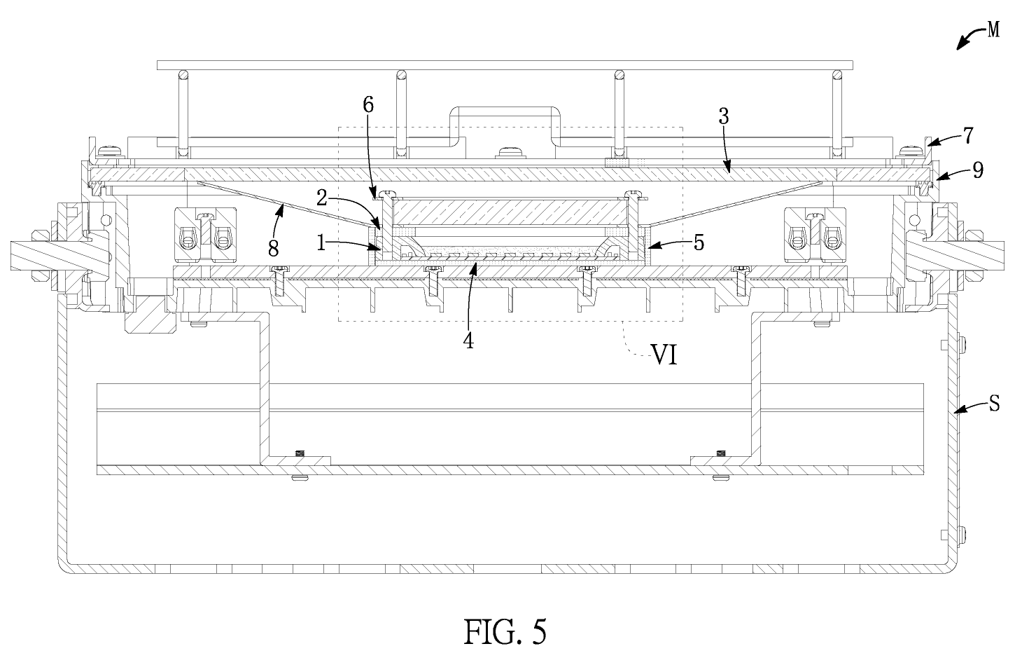

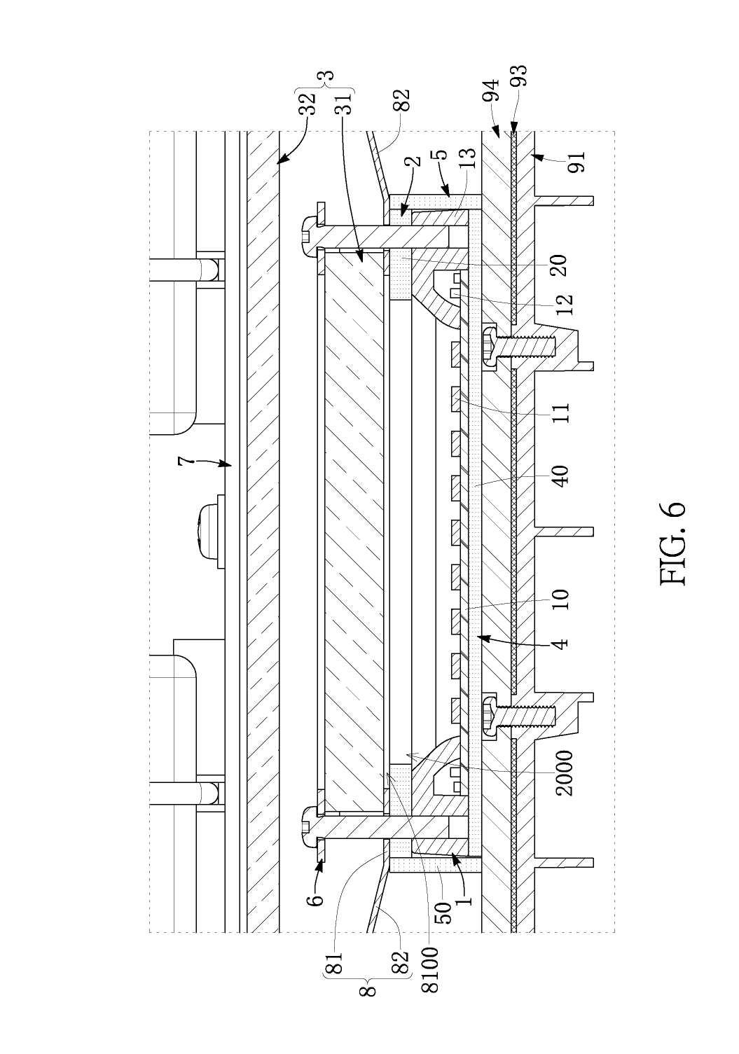

More particularly, referring to FIG. 2, FIG. 5 and FIG. 6, the illumination light generating structure 1 may at least include a circuit substrate 10 and a plurality of LED elements 11, and the LED elements 11 can be disposed on the circuit substrate 10 and electrically connected to the circuit substrate 10 by flip-chip bonding. For example, each of the LED elements 11 can be configured as an alternating current LED chip (i.e., AC LED chip that can be an unpackaged bare chip or bare die, or a packaged LED chip), and the LED elements 11 can be packaged by silicone or epoxy. It should be noted that the illumination light generating structure 1 may further include a plurality of electronic components 12 and an anti-radiation insulating cover 13, and the LED elements 11 and the electronic components 12 of the illumination light generating structure 1 can be sealed in a closed space (or a sealed space ) formed by the top anti-radiation element 20, the first anti-radiation light-transmitting element 31, the bottom anti-radiation element 40 and the surrounding anti-radiation element 50, so that the LED elements 11 and the electronic components 12 of the illumination light generating structure 1 can be used in a high temperature and high pressure environment. More particularly, the electronic components 12 can be disposed on the circuit substrate 10 and electrically connected to the circuit substrate 10, and each of the electronic components 12 can be configured as one of a capacitor (such as conventional capacitor or chip-type capacitor), an inductor (such as conventional inductor or chip-type inductor), a resistor (such as conventional resistor or chip-type resistor), a current-limiting component (such as conventional current limiter or chip-type current limiter) and a rectifier (such as conventional rectifier or chip-type rectifier), or any type of electronic components or electronic chips. In addition, the anti-radiation insulating cover 13 can be disposed on the circuit substrate 10 to cover the electronic components 12, and the anti-radiation insulating cover 13 can be configured as a titanium-containing insulating cover (such as a titanium-containing insulating package body that may at least include PBT (Polybutylene terephthalate) and titanium dioxide) or a metal-containing insulating cover. However, the aforementioned details are disclosed for exemplary purposes only, and are not meant to limit the scope of the present disclosure.

More particularly, referring to FIG. 2, FIG. 5 and FIG. 6, the top anti-radiation structure 2 may at least include a top anti-radiation element 20 that can be disposed above the illumination light generating structure 1. For example, the top anti-radiation element 20 can be configured as a lead-containing surrounding cover plate (or a metal-containing surrounding cover) that can be detachably disposed on the anti-radiation insulating cover 13 of the illumination light generating structure 1 through a plurality of screws. Moreover, the top anti-radiation element 20 has a through opening 2000, and the through opening 2000 provided by the top anti-radiation element 20 can be configured to correspond to the LED elements 11 and expose LED elements 11. In addition, the thickness of the top anti-radiation element 20 can be between 1000 μm and 5000 μm (such as any positive integer between 1000 μm and 5000 μm) according to different requirements. However, the aforementioned details are disclosed for exemplary purposes only, and are not meant to limit the scope of the present disclosure.

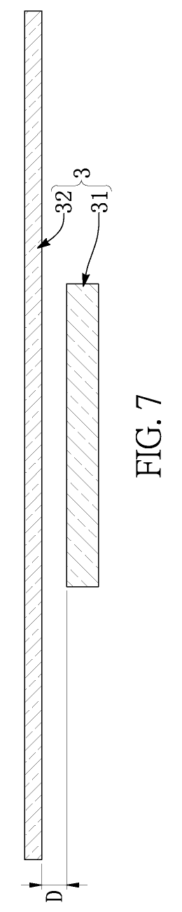

More particularly, referring to FIG. 1, FIG. 2, FIG. 5 and FIG. 6, the anti-radiation light-transmitting structure 3 may at least include a first anti-radiation light-transmitting element 31 and a second anti-radiation light-transmitting element 32, the first anti-radiation light-transmitting element 31 can be disposed above the illumination light generating structure 1, and the second anti-radiation light-transmitting element 32 can be disposed above the first anti-radiation light-transmitting element 31. For example, the anti-radiation light-transmitting structure 3 can be configured to be separated from the illumination light generating structure 1 by a predetermined distance, and the first anti-radiation light-transmitting element 31 and the second anti-radiation light-transmitting element 32 can be configured to be separated from each other by a predetermined distance D (as shown in FIG. 7). Furthermore, the first anti-radiation light-transmitting element 31 can be configured as a first lead-containing light-transmitting element (or a metal-containing light-transmitting element) or a first boron-containing light-transmitting element (or a non-metallic-containing light-transmitting element) that can be detachably disposed above the illumination light generating structure 1, and the second anti-radiation light-transmitting element 32 can be configured as a second lead-containing light-transmitting element (or a metal-containing light-transmitting element) or a second boron-containing light-transmitting element (or a non-metallic-containing light-transmitting element) that can be detachably disposed above the illumination light generating structure 1. Moreover, the first anti-radiation light-transmitting element 31 can be configured as a first radiation-resistant light-transmitting plate without a through hole (or a first non-perforated anti-radiation light-transmitting plate), and the second anti-radiation light-transmitting element 32 can be configured as a second radiation-resistant light-transmitting plate without a through hole (or a second non-perforated anti-radiation light-transmitting plate). In addition, according to different requirements, the thickness of the first anti-radiation light-transmitting element 31 can be between 1000 μm and 5000 μm (such as any positive integer between 1000 μm and 5000 μm), and the thickness of the second anti-radiation light-transmitting element 32 can be between 1000 μm and 5000 μm (such as any positive integer between 1000 μm and 5000 μm). It should be noted that the first anti-radiation light-transmitting element 31 can be configured to be detachably disposed above the illumination light generating structure 1 through the positioning or fixing means of a first position-limiting structure 6, and the second anti-radiation light-transmitting element 32 can be configured to be detachably disposed above the first anti-radiation light-transmitting element 31 through the positioning or fixing means of a second position-limiting structure 7. However, the aforementioned details are disclosed for exemplary purposes only, and are not meant to limit the scope of the present disclosure.

More particularly, referring to FIG. 2, FIG. 5 and FIG. 6, the bottom anti-radiation structure 4 may at least include a bottom anti-radiation element 40 that can be disposed below the illumination light generating structure 1. For example, the bottom anti-radiation structure 4 can be configured to directly or indirectly contact the circuit substrate 10 of the illumination light generating structure 1. Moreover, the bottom anti-radiation element 40 can be configured as an anti-radiation heat dissipation element (such as a metal heat sink) that can detachably and directly (or indirectly) contact the circuit substrate 10. In addition, the thickness of the bottom anti-radiation element 40 can be between 1000 μm and 5000 μm (such as any positive integer between 1000 μm and 5000 μm) according to different requirements. However, the aforementioned details are disclosed for exemplary purposes only, and are not meant to limit the scope of the present disclosure.

More particularly, referring to FIG. 2, FIG. 5 and FIG. 6, the surrounding anti-radiation structure 5 may at least include a surrounding anti-radiation element 50 that can be disposed around the illumination light generating structure 1. For example, the surrounding anti-radiation element 50 can be configured as a tungsten-containing surrounding cover body (or a metal-containing surrounding cover body) that can detachably surround the top anti-radiation element 20, the illumination light generating structure 1 and the bottom anti-radiation element 40. In addition, the thickness of the surrounding anti-radiation element 50 can be between 1000 μm and 5000 μm (such as any positive integer between 1000 μm and 5000 μm) according to different requirements. It should be noted that the surrounding anti-radiation element 50 can be a complete and continuous surrounding element, or the surrounding anti-radiation element 50 can also have a slot or a slit for the electric wire to pass through. However, the aforementioned details are disclosed for exemplary purposes only, and are not meant to limit the scope of the present disclosure.

More particularly, referring to FIG. 2, FIG. 5, FIG. 6 and FIG. 7, when the first anti-radiation light-transmitting element 31 and the second anti-radiation light-transmitting element 32 can be configured to be separated from each other by the predetermined distance D (that is to say, the first anti-radiation light-transmitting element 31 and the second anti-radiation light-transmitting element 32 may be two independent optical components), the anti-radiation LED lamp module M further includes a light-reflecting cover structure 8 that can be disposed between the top anti-radiation element 20 and the first anti-radiation light-transmitting element 31. More particularly, the light-reflecting cover structure 8 may at least include a carrying base 81 (or a carrying substrate, or a supporting base) and a plurality of light-reflecting elements 82, the carrying base 81 can be disposed on the top anti-radiation element 20, the carrying base 81 has a through opening 8100 for exposing the LED elements 11, and the light-reflecting elements 82 can be surroundingly connected to the carrying base 81 (or the light-reflecting elements 82 can be sequentially connected to each other and surround the carrying base 81). In addition, the top anti-radiation element 20 can be configured to carry the carrying base 81, and the carrying base 81 can be configured to carry the first anti-radiation light-transmitting element 31 (or the first anti-radiation light-transmitting element 31 can be configured to be detachably disposed on the carrying base 81). It should be noted that in one of the feasible embodiments, when the first anti-radiation light-transmitting element 31 can be configured as the first lead-containing light-transmitting element, the first lead-containing light-transmitting element can be configured as a first lead-containing glass plate or a first lead-containing plastic plate that can be detachably disposed on the carrying base 81. In one of the feasible embodiments, when the first anti-radiation light-transmitting element 31 can be configured as the first boron-containing light-transmitting element, the first boron-containing light-transmitting element can be configured as a first boron-containing glass plate or a first boron-containing plastic plate that can be detachably disposed on the carrying base 81. However, the aforementioned details are disclosed for exemplary purposes only, and are not meant to limit the scope of the present disclosure.

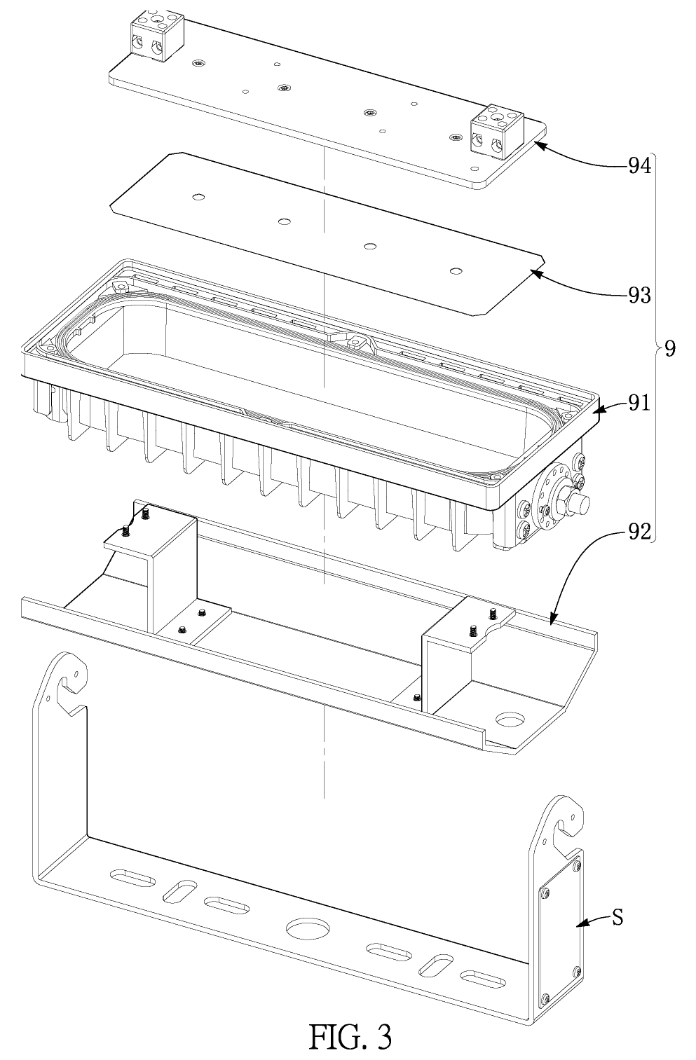

It should be noted that, for example, referring to FIG. 1, FIG. 3, FIG. 5 and FIG. 6, the radiation-resistant LED lamp module M further includes an anti-radiation lamp carrying structure 9 that may at least include a lamp housing 91, a stainless steel carrying seat 92, a graphite-containing substrate 93 and an aluminum-containing substrate 94, the stainless steel carrying seat 92 can be detachably disposed on the lamp housing 91, the graphite-containing substrate 93 can be detachably disposed in the lamp housing 91, the aluminum-containing substrate 94 can be detachably disposed on the graphite-containing substrate 93, and the aluminum-containing substrate 94 can be configured to carry the bottom anti-radiation element 40 and the surrounding anti-radiation element 50. More particularly, according to different requirements, the thickness of the stainless steel carrying seat 92 can be between 1000 μm and 5000 μm (such as any positive integer between 1000 μm and 5000 μm), the thickness of the graphite-containing substrate 93 can be between 1000 μm and 5000 μm (such as any positive integer between 1000 μm and 5000 μm), and the thickness of the aluminum-containing substrate 94 can be between 3000 μm and 7000 μm (such as any positive integer between 3000 μm and 7000 μm). It should be noted that in one of the feasible embodiments, when the second anti-radiation light-transmitting element 32 can be configured as the second lead-containing light-transmitting element, the second lead-containing light-transmitting element can be configured as a second lead-containing glass plate or a second lead-containing plastic plate that can be detachably disposed on the lamp housing 91 (that is to say, the second anti-radiation light-transmitting element 32 can be configured to be detachably disposed on a lamp housing 91). In one of the feasible embodiments, when the second anti-radiation light-transmitting element 32 can be configured as the second boron-containing light-transmitting element, the second boron-containing light-transmitting element can be configured as a second boron-containing glass plate or a second boron-containing plastic plate that can be detachably disposed on the lamp housing 91. However, the aforementioned details are disclosed for exemplary purposes only, and are not meant to limit the scope of the present disclosure.

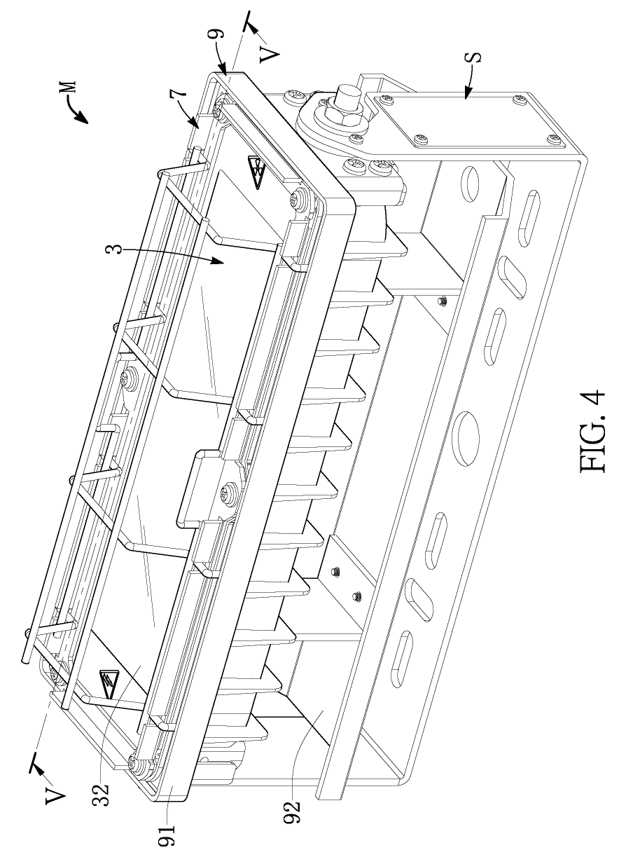

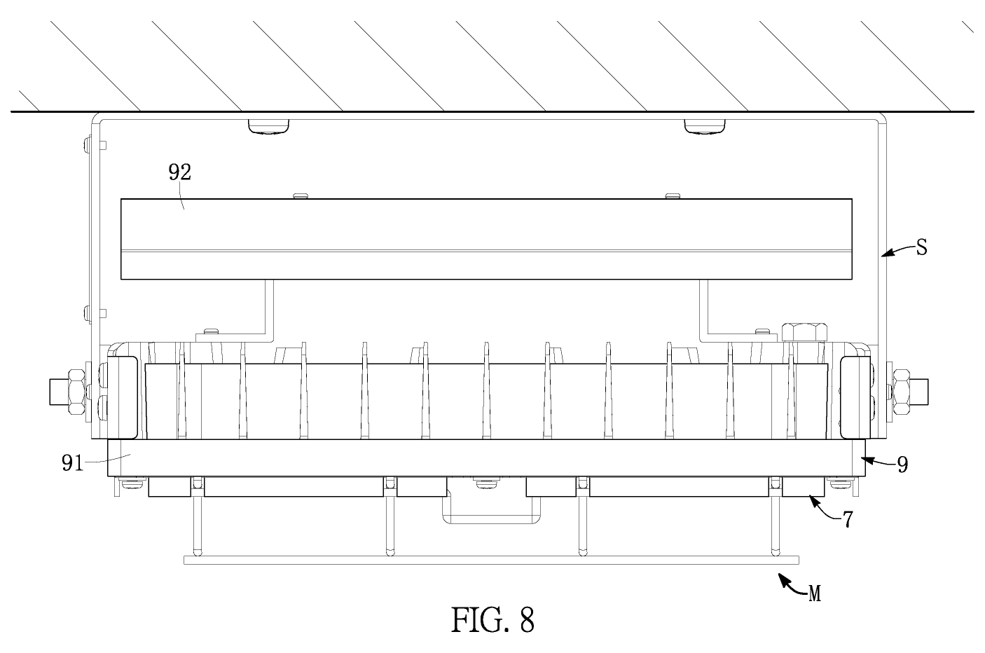

It should be noted that, for example, referring to FIG. 4 and FIG. 8, the lamp housing 91 can be configured to be detachably and movably disposed on a ceiling support structure S (or a ceiling bracket structure), so that the placement angle of the radiation-resistant LED lamp module M can be adjusted relative to the ceiling support structure S. Therefore, in one of the feasible embodiments, when the radiation-resistant LED lamp module M is installed in a high-radiation environment (such as an electromagnetic wave environment with X-rays or gamma rays, or a particle radiation environment with alpha rays, beta rays or neutron radiation) through the ceiling support structure S, the illumination light generating structure 1 can be at least completely enclosed or sealed through the cooperation of the top anti-radiation element 20, the first anti-radiation light-transmitting element 31, the bottom anti-radiation element 40 and the surrounding anti-radiation element 50 (or through the cooperation of the top anti-radiation element 20, the first anti-radiation light-transmitting element 31, the second anti-radiation light-transmitting element 32, the bottom anti-radiation element 40, the surrounding anti-radiation element 50, the light-reflecting cover structure 8 and the anti-radiation lamp carrying structure 9), so that the radiation damage that the illumination light generating structure 1 may suffer in the high-radiation environment can be effectively reduced. However, the aforementioned details are disclosed for exemplary purposes only, and are not meant to limit the scope of the present disclosure.

It should be noted that, for example, referring to FIG. 1, FIG. 4 and FIG. 8, an outer surrounding area of the second anti-radiation light-transmitting element 32 can be configured to provide radiation-resistant level information (for example, different colors or different patterns can represent different radiation absorption doses, thereby improving the product grade recognition of the radiation-resistant LED lamp module M). Therefore, even when the radiation-resistant LED lamp module M has been installed in a high radiation environment through the ceiling support structure S, the user can still obtain or understand the radiation-resistant level of the radiation-resistant LED lamp module M through the radiation-resistant level information (for example, the radiation absorption dose can be 156 kGy or 312 kGy) provided by an outer surrounding area (or an inner surrounding area) of the second anti-radiation light-transmitting element 32. However, the aforementioned details are disclosed for exemplary purposes only, and are not meant to limit the scope of the present disclosure.

It should be noted that, for example, referring to FIG. 5 and FIG. 6, the vertical projection of each of the LED elements 11 can completely fall on the first anti-radiation light-transmitting element 31 and the bottom anti-radiation structure 4 (that is to say, the LED elements 11 can be disposed between the first anti-radiation light-transmitting element 31 and the bottom anti-radiation structure 4 at the same time, and the horizontal distribution area of the LED elements 11 is smaller than the horizontal distribution area of the first anti-radiation light-transmitting element 31 or the horizontal distribution area of the bottom anti-radiation structure 4), and the vertical projection of each of the electronic components 12 can completely fall on the top anti-radiation element 20 and the bottom anti-radiation structure 4 (that is to say, the electronic components 12 can be disposed between the top anti-radiation element 20 and the bottom anti-radiation structure 4 at the same time, and the horizontal distribution area of the electronic components 12 is smaller than the horizontal distribution area of the top anti-radiation element 20 or the horizontal distribution area of the bottom anti-radiation structure 4). However, the aforementioned details are disclosed for exemplary purposes only, and are not meant to limit the scope of the present disclosure.

It should be noted that, for example, referring to FIG. 5, FIG. 6 and FIG. 8, in the case where the radiation-resistant LED lamp module M is installed in a high radiation environment through the ceiling support structure S, when the LED elements 11 can be configured to generate an illumination light beam (or illumination light source), the illumination light beam generated by the LED elements 11 can sequentially pass through the through opening 2000 of the top anti-radiation element 20, the through opening 8100 of the carrying base 81, the first anti-radiation light-transmitting element 31, and the second anti-radiation light-transmitting element 32, thereby providing the illumination light source required by the user. However, the aforementioned details are disclosed for exemplary purposes only, and are not meant to limit the scope of the present disclosure.

### Second Embodiment

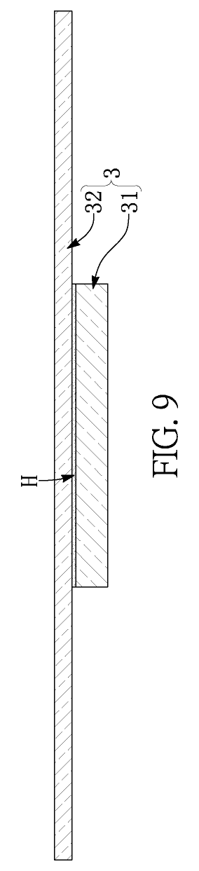

Referring to FIG. 9, a second embodiment of the present disclosure provides an anti-radiation light-transmitting structure 3, which can be applied to a radiation-resistant light-emitting diode lamp module. By comparing FIG. 9 with FIG. 7, the main difference between the second embodiment and the first embodiment is as follows: in the second embodiment, the second anti-radiation light-transmitting element 32 can be positioned on the first anti-radiation light-transmitting element 31 through an adhesive layer H, so that the first anti-radiation light-transmitting element 31 and the second anti-radiation light-transmitting element 32 can be combined into a single-piece optical component through the adhesive layer H. For example, according to different requirements, the radiation-resistant LED lamp module M provided in the first embodiment can selectively adopt the anti-radiation light-transmitting structure 3 provided in the first embodiment (as shown in FIG. 7) or the anti-radiation light-transmitting structure 3 provided in the second embodiment (as shown in FIG. 9).

### Third Embodiment

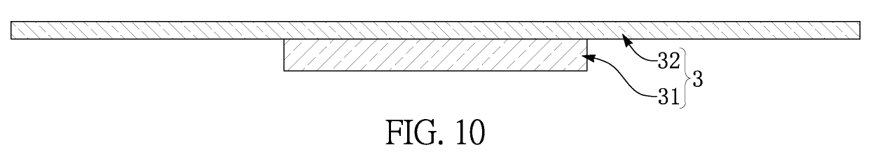

Referring to FIG. 10, a third embodiment of the present disclosure provides an anti-radiation light-transmitting structure 3, which can be applied to a radiation-resistant light-emitting diode lamp module. By comparing FIG. 10 with FIG. 7 (or FIG. 9), the main difference between the third embodiment and the first embodiment (or the second embodiment) is as follows: in the third embodiment, the first anti-radiation light-transmitting element 31 and the second anti-radiation light-transmitting element 32 can be configured to be stacked on top of one another or in direct contact with each other (that is to say, the first anti-radiation light-transmitting element 31 and the second anti-radiation light-transmitting element 32 can be two independent optical components, respectively). For example, according to different requirements, the radiation-resistant LED lamp module M provided in the first embodiment can selectively adopt the anti-radiation light-transmitting structure 3 provided in the first embodiment (as shown in FIG. 7), the anti-radiation light-transmitting structure 3 provided in the second embodiment (as shown in FIG. 9), or the anti-radiation light-transmitting structure 3 provided in the third embodiment (as shown in FIG. 10).

### Beneficial Effects of the Embodiments

In conclusion, in the radiation-resistant LED lamp module M provided by the present disclosure, by virtue of “the top anti-radiation structure 2 including a top anti-radiation element 20 disposed above the illumination light generating structure 1,” “the anti-radiation light-transmitting structure 3 including a first anti-radiation light-transmitting element 31 disposed above the illumination light generating structure 1 and a second anti-radiation light-transmitting element 32 disposed above the first anti-radiation light-transmitting element 31,” “the bottom anti-radiation structure 4 including a bottom anti-radiation element 40 disposed below the illumination light generating structure 1” and “the surrounding anti-radiation structure 5 including a surrounding anti-radiation element 50 disposed around the illumination light generating structure 1,” the radiation damage to the illumination light generating structure 1 in high radiation environments can be reduced.

It is noteworthy that the radiation-resistant LED lamp module M provided by the present disclosure has undergone neutron irradiation reliability verification. The module is capable of maintaining normal operational performance under accumulated neutron fluence conditions of 1×10¹³ n/cm², 5×10¹³ n/cm², and 1×10¹⁴ n/cm², without significant luminous degradation, structural deterioration, or functional failure. Therefore, the packaging materials, optoelectronic components, and metal structures utilized in the anti-radiation LED lighting module M possess high displacement damage tolerance (DDT), allowing the module to meet the neutron tolerance specifications required for applications in high-energy radiation environments, particle accelerator peripheral equipment, space radiation missions, and nuclear facilities.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A radiation-resistant LED lamp module, comprising:
an illumination light generating structure including a circuit substrate and a plurality of LED elements disposed on the circuit substrate;
a top anti-radiation structure including a top anti-radiation element disposed above the illumination light generating structure;
an anti-radiation light-transmitting structure including a first anti-radiation light-transmitting element disposed above the illumination light generating structure and a second anti-radiation light-transmitting element disposed above the first anti-radiation light-transmitting element;
a bottom anti-radiation structure including a bottom anti-radiation element disposed below the illumination light generating structure; and
a surrounding anti-radiation structure including a surrounding anti-radiation element disposed around the illumination light generating structure;
wherein the anti-radiation light-transmitting structure is configured to be separated from the illumination light generating structure, and the bottom anti-radiation structure is configured to contact the circuit substrate of the illumination light generating structure;
wherein the first anti-radiation light-transmitting element is configured as a first lead-containing light-transmitting element or a first boron-containing light-transmitting element detachably disposed above the illumination light generating structure, and the second anti-radiation light-transmitting element is configured as a second lead-containing light-transmitting element or a second boron-containing light-transmitting element detachably disposed above the illumination light generating structure; and
wherein the illumination light generating structure is completely enclosed by the top anti-radiation element, the first anti-radiation light-transmitting element, the bottom anti-radiation element and the surrounding anti-radiation element.

2. The radiation-resistant LED lamp module according to claim 1,
wherein the illumination light generating structure further includes a plurality of electronic components disposed on the circuit substrate and an anti-radiation insulating cover disposed on the circuit substrate to cover the electronic components;
wherein the LED elements and the electronic components of the illumination light generating structure are sealed in a closed space formed by the top anti-radiation element, the first anti-radiation light-transmitting element, the bottom anti-radiation element and the surrounding anti-radiation element;
wherein each of the LED elements is configured as an alternating current LED chip, each of the electronic components is configured as one of a capacitor, an inductor, a resistor, a current-limiting component and a rectifier, and the anti-radiation insulating cover is configured as a titanium-containing insulating cover;
wherein a vertical projection of each of the LED elements completely falls on the first anti-radiation light-transmitting element and the bottom anti-radiation structure, and a vertical projection of each of the electronic components completely falls on the top anti-radiation element and the bottom anti-radiation structure;
wherein the first anti-radiation light-transmitting element is configured to be detachably disposed on a carrying base, and the second anti-radiation light-transmitting element is configured to be detachably disposed on a lamp housing;
wherein, when the first anti-radiation light-transmitting element is configured as the first lead-containing light-transmitting element, the first lead-containing light-transmitting element is configured as a first lead-containing glass plate or a first lead-containing plastic plate detachably disposed on the carrying base;
wherein, when the first anti-radiation light-transmitting element is configured as the first boron-containing light-transmitting element, the first boron-containing light-transmitting element is configured as a first boron-containing glass plate or a first boron-containing plastic plate detachably disposed on the carrying base;
wherein, when the second anti-radiation light-transmitting element is configured as the second lead-containing light-transmitting element, the second lead-containing light-transmitting element is configured as a second lead-containing glass plate or a second lead-containing plastic plate detachably disposed on the lamp housing;
wherein, when the second anti-radiation light-transmitting element is configured as the second boron-containing light-transmitting element, the second boron-containing light-transmitting element is configured as a second boron-containing glass plate or a second boron-containing plastic plate detachably disposed on the lamp housing;
wherein the first anti-radiation light-transmitting element is configured as a first radiation-resistant light-transmitting plate without a through hole, and the second anti-radiation light-transmitting element is configured as a second radiation-resistant light-transmitting plate without a through hole;
wherein the first anti-radiation light-transmitting element is configured to be detachably disposed above the illumination light generating structure through a first position-limiting structure, and the second anti-radiation light-transmitting element is configured to be detachably disposed above the first anti-radiation light-transmitting element through a second position-limiting structure; and
wherein an outer surrounding area of the second anti-radiation light-transmitting element is configured to provide radiation-resistant level information.

3. The radiation-resistant LED lamp module according to claim 1,
wherein the first anti-radiation light-transmitting element and the second anti-radiation light-transmitting element are configured to be separated from each other by a predetermined distance or to be stacked on each other;
wherein, when the first anti-radiation light-transmitting element and the second anti-radiation light-transmitting element are configured to be separated from each other by the predetermined distance, the anti-radiation LED lamp module further comprises: a light-reflecting cover structure disposed between the top anti-radiation element and the first anti-radiation light-transmitting element;
wherein the light-reflecting cover structure includes a carrying base disposed on the top anti-radiation element and a plurality of light-reflecting elements surroundingly connected to the carrying base, and the light-reflecting elements are connected to each other in sequence to surround the carrying base;
wherein the top anti-radiation element is configured to carry the carrying base, and the carrying base is configured to carry the first anti-radiation light-transmitting element;
wherein the top anti-radiation element has a through opening for exposing the LED elements, and the carrying base has a through opening for exposing the LED elements; and
wherein, when the LED elements are configured to generate an illumination light beam, the illumination light beam generated by the LED elements sequentially passes through the through opening of the top anti-radiation element, the through opening of the carrying base, the first anti-radiation light-transmitting element, and the second anti-radiation light-transmitting element.

4. The radiation-resistant LED lamp module according to claim 1,
wherein the radiation-resistant LED lamp module further comprises: an anti-radiation lamp carrying structure including a lamp housing, a stainless steel carrying seat detachably disposed on the lamp housing, a graphite-containing substrate detachably disposed in the lamp housing, and an aluminum-containing substrate detachably disposed on the graphite-containing substrate;
wherein the lamp housing is configured to be detachably and movably disposed on a ceiling support structure, and the aluminum-containing substrate is configured to carry the bottom anti-radiation element and the surrounding anti-radiation element;
wherein the top anti-radiation element is configured as a lead-containing surrounding cover plate detachably disposed on the illumination light generating structure, the bottom anti-radiation element is configured as an anti-radiation heat dissipation element detachably contacting the circuit substrate, and the surrounding anti-radiation element is configured as a tungsten-containing surrounding cover body detachably surrounding the top anti-radiation element, the illumination light generating structure and the bottom anti-radiation element; and
wherein a thickness of the top anti-radiation element is between 1000 μm and 5000 μm, a thickness of the first anti-radiation light-transmitting element is between 1000 μm and 5000 μm, a thickness of the second anti-radiation light-transmitting element is between 1000 μm and 5000 μm, a thickness of the bottom anti-radiation element is between 1000 μm and 5000 μm, a thickness of the surrounding anti-radiation element is between 1000 μm and 5000 μm, a thickness of the stainless steel carrying seat is between 1000 μm and 5000 μm, a thickness of the graphite-containing substrate is between 1000 μm and 5000 μm, and a thickness of the aluminum-containing substrate is between 3000 μm and 7000 μm.

5. A radiation-resistant LED lamp module, comprising:
an illumination light generating structure including a circuit substrate and a plurality of LED elements disposed on the circuit substrate;
a top anti-radiation structure including a top anti-radiation element disposed above the illumination light generating structure;
an anti-radiation light-transmitting structure including a first anti-radiation light-transmitting element disposed above the illumination light generating structure and a second anti-radiation light-transmitting element disposed above the first anti-radiation light-transmitting element;
a bottom anti-radiation structure including a bottom anti-radiation element disposed below the illumination light generating structure; and
a surrounding anti-radiation structure including a surrounding anti-radiation element disposed around the illumination light generating structure;
wherein the first anti-radiation light-transmitting element is configured as a first lead-containing light-transmitting element or a first boron-containing light-transmitting element detachably disposed above the illumination light generating structure, and the second anti-radiation light-transmitting element is configured as a second lead-containing light-transmitting element or a second boron-containing light-transmitting element detachably disposed above the illumination light generating structure.

6. The radiation-resistant LED lamp module according to claim 5,
wherein the illumination light generating structure further includes a plurality of electronic components disposed on the circuit substrate and an anti-radiation insulating cover disposed on the circuit substrate to cover the electronic components;
wherein the LED elements and the electronic components of the illumination light generating structure are sealed in a closed space formed by the top anti-radiation element, the first anti-radiation light-transmitting element, the bottom anti-radiation element and the surrounding anti-radiation element;
wherein each of the LED elements is configured as an alternating current LED chip, each of the electronic components is configured as one of a capacitor, an inductor, a resistor, a current-limiting component and a rectifier, and the anti-radiation insulating cover is configured as a titanium-containing insulating cover;
wherein a vertical projection of each of the LED elements completely falls on the first anti-radiation light-transmitting element and the bottom anti-radiation structure, and a vertical projection of each of the electronic components completely falls on the top anti-radiation element and the bottom anti-radiation structure;
wherein the first anti-radiation light-transmitting element is configured to be detachably disposed on a carrying base, and the second anti-radiation light-transmitting element is configured to be detachably disposed on a lamp housing;
wherein, when the first anti-radiation light-transmitting element is configured as the first lead-containing light-transmitting element, the first lead-containing light-transmitting element is configured as a first lead-containing glass plate or a first lead-containing plastic plate detachably disposed on the carrying base;
wherein, when the first anti-radiation light-transmitting element is configured as the first boron-containing light-transmitting element, the first boron-containing light-transmitting element is configured as a first boron-containing glass plate or a first boron-containing plastic plate detachably disposed on the carrying base;
wherein, when the second anti-radiation light-transmitting element is configured as the second lead-containing light-transmitting element, the second lead-containing light-transmitting element is configured as a second lead-containing glass plate or a second lead-containing plastic plate detachably disposed on the lamp housing;
wherein, when the second anti-radiation light-transmitting element is configured as the second boron-containing light-transmitting element, the second boron-containing light-transmitting element is configured as a second boron-containing glass plate or a second boron-containing plastic plate detachably disposed on the lamp housing;
wherein the first anti-radiation light-transmitting element is configured as a first radiation-resistant light-transmitting plate without a through hole, and the second anti-radiation light-transmitting element is configured as a second radiation-resistant light-transmitting plate without a through hole;
wherein the first anti-radiation light-transmitting element is configured to be detachably disposed above the illumination light generating structure through a first position-limiting structure, and the second anti-radiation light-transmitting element is configured to be detachably disposed above the first anti-radiation light-transmitting element through a second position-limiting structure; and
wherein an outer surrounding area of the second anti-radiation light-transmitting element is configured to provide radiation-resistant level information.

7. The radiation-resistant LED lamp module according to claim 5,
wherein the first anti-radiation light-transmitting element and the second anti-radiation light-transmitting element are configured to be separated from each other by a predetermined distance or to be stacked on each other;
wherein, when the first anti-radiation light-transmitting element and the second anti-radiation light-transmitting element are configured to be separated from each other by the predetermined distance, the anti-radiation LED lamp module further comprises: a light-reflecting cover structure disposed between the top anti-radiation element and the first anti-radiation light-transmitting element;
wherein the light-reflecting cover structure includes a carrying base disposed on the top anti-radiation element and a plurality of light-reflecting elements surroundingly connected to the carrying base, and the light-reflecting elements are connected to each other in sequence to surround the carrying base;
wherein the top anti-radiation element is configured to carry the carrying base, and the carrying base is configured to carry the first anti-radiation light-transmitting element;
wherein the top anti-radiation element has a through opening for exposing the LED elements, and the carrying base has a through opening for exposing the LED elements; and
wherein, when the LED elements are configured to generate an illumination light beam, the illumination light beam generated by the LED elements sequentially passes through the through opening of the top anti-radiation element, the through opening of the carrying base, the first anti-radiation light-transmitting element, and the second anti-radiation light-transmitting element.

8. The radiation-resistant LED lamp module according to claim 5,
wherein the radiation-resistant LED lamp module further comprises: an anti-radiation lamp carrying structure including a lamp housing, a stainless steel carrying seat detachably disposed on the lamp housing, a graphite-containing substrate detachably disposed in the lamp housing, and an aluminum-containing substrate detachably disposed on the graphite-containing substrate;
wherein the lamp housing is configured to be detachably and movably disposed on a ceiling support structure, and the aluminum-containing substrate is configured to carry the bottom anti-radiation element and the surrounding anti-radiation element;
wherein the top anti-radiation element is configured as a lead-containing surrounding cover plate detachably disposed on the illumination light generating structure, the bottom anti-radiation element is configured as an anti-radiation heat dissipation element detachably contacting the circuit substrate, and the surrounding anti-radiation element is configured as a tungsten-containing surrounding cover body detachably surrounding the top anti-radiation element, the illumination light generating structure and the bottom anti-radiation element; and
wherein a thickness of the top anti-radiation element is between 1000 μm and 5000 μm, a thickness of the first anti-radiation light-transmitting element is between 1000 μm and 5000 μm, a thickness of the second anti-radiation light-transmitting element is between 1000 μm and 5000 μm, a thickness of the bottom anti-radiation element is between 1000 μm and 5000 μm, a thickness of the surrounding anti-radiation element is between 1000 μm and 5000 μm, a thickness of the stainless steel carrying seat is between 1000 μm and 5000 μm, a thickness of the graphite-containing substrate is between 1000 μm and 5000 μm, and a thickness of the aluminum-containing substrate is between 3000 μm and 7000 μm.

9. A radiation-resistant LED lamp module, comprising:
an illumination light generating structure including a circuit substrate and a plurality of LED elements disposed on the circuit substrate;
a top anti-radiation structure including a top anti-radiation element disposed above the illumination light generating structure;
an anti-radiation light-transmitting structure including a first anti-radiation light-transmitting element disposed above the illumination light generating structure and a second anti-radiation light-transmitting element disposed above the first anti-radiation light-transmitting element;
a bottom anti-radiation structure including a bottom anti-radiation element disposed below the illumination light generating structure; and
a surrounding anti-radiation structure including a surrounding anti-radiation element disposed around the illumination light generating structure;
wherein the illumination light generating structure is completely enclosed by the top anti-radiation element, the first anti-radiation light-transmitting element, the bottom anti-radiation element and the surrounding anti-radiation element.

10. The radiation-resistant LED lamp module according to claim 9,
wherein the illumination light generating structure further includes a plurality of electronic components disposed on the circuit substrate and an anti-radiation insulating cover disposed on the circuit substrate to cover the electronic components;
wherein the LED elements and the electronic components of the illumination light generating structure are sealed in a closed space formed by the top anti-radiation element, the first anti-radiation light-transmitting element, the bottom anti-radiation element and the surrounding anti-radiation element;
wherein a vertical projection of each of the LED elements completely falls on the first anti-radiation light-transmitting element and the bottom anti-radiation structure, and a vertical projection of each of the electronic components completely falls on the top anti-radiation element and the bottom anti-radiation structure;
wherein the first anti-radiation light-transmitting element is configured as a first radiation-resistant light-transmitting plate without a through hole, and the second anti-radiation light-transmitting element is configured as a second radiation-resistant light-transmitting plate without a through hole;
wherein the first anti-radiation light-transmitting element is configured to be detachably disposed above the illumination light generating structure through a first position-limiting structure, and the second anti-radiation light-transmitting element is configured to be detachably disposed above the first anti-radiation light-transmitting element through a second position-limiting structure;
wherein an outer surrounding area of the second anti-radiation light-transmitting element is configured to provide radiation-resistant level information;
wherein the anti-radiation LED lamp module further comprises: a light-reflecting cover structure disposed between the top anti-radiation element and the first anti-radiation light-transmitting element;
wherein the light-reflecting cover structure includes a carrying base disposed on the top anti-radiation element and a plurality of light-reflecting elements surroundingly connected to the carrying base, and the light-reflecting elements are connected to each other in sequence to surround the carrying base;
wherein the radiation-resistant LED lamp module further comprises: an anti-radiation lamp carrying structure including a lamp housing, a stainless steel carrying seat detachably disposed on the lamp housing, a graphite-containing substrate detachably disposed in the lamp housing, and an aluminum-containing substrate detachably disposed on the graphite-containing substrate; and
wherein the top anti-radiation element is configured as a lead-containing surrounding cover plate detachably disposed on the illumination light generating structure, the bottom anti-radiation element is configured as an anti-radiation heat dissipation element detachably contacting the circuit substrate, and the surrounding anti-radiation element is configured as a tungsten-containing surrounding cover body detachably surrounding the top anti-radiation element, the illumination light generating structure and the bottom anti-radiation element.
